(19) United States
(12) Patent Application Publication
(10) Pub. No.: US 2007/0018455 A1
(43) Pub. Date: Jan. 25, 2007

(54) Apparatus and methods for fusing non-cylindrical thermoplastic pipe ends

(75) Inventors: William A. Bezner, Gainesville, TX (US); John D. Crabtree, Gainesville, TX (US)

Correspondence Address: NIXON & VANDERHYE, PC, 901 NORTH GLEBE ROAD, 11TH FLOOR, ARLINGTON, VA, 22203, US

(73) Assignee: Pipe Liners, Inc.

(21) Appl. No.: 11/185,980

(22) Filed: Jul. 21, 2005

(51) Int. Cl. F16L 21/02

(52) U.S. Cl. 285/370

(57) ABSTRACT

Deformed pipes used for lining host pipes are provided with internal and external inserts to maintain generally U-shaped cross-sectional configuration of the pipe ends. When the pipes are transported to an installation site, the thermoplastic pipe ends with inserts applied match one another, enabling the pipe ends to be fused to one another. Upon locating the pipes within the host pipe, the interior inserts can be removed by floating the inserts through an open end of the pipe or using a “pig” drawn through the pipe.

### BACKGROUND OF THE INVENTION

The present invention relates to apparatus and methods for fusing ends of thermoplastic pipes having non-cylindrical cross-sections to one another and particularly relates to apparatus and methods for fusing thermoplastic pipe ends having generally U-shaped cross-sections to one another.

Apparatus and methods for lining a host pipe such as a concrete sewer line with a thermoplastic liner are well known. One such system for lining pipes involves the manufacture of generally cylindrical pipe liners formed of thermoplastic materials. After extrusion, the cylindrical liners are shaped to reduce their cross-sectional envelope. Various methods and apparatus have been used to deform the initially extruded cylindrical liner into various cross-sectional configurations, for example, H, X, U and V cross-sections. A generally U-shaped liner has been found to be most useful, practical and economical. Thus, the extruded cylindrical liner is reduced into a substantially U-shaped cross-sectional configuration symmetrical about a plane of bilateral symmetry passing through the axis of the cylindrical cross-section of the liner providing a deformed tubular liner with reduced cross-sectional envelope.

Subsequent to the formation of the deformed liner at the manufacturing site, the liner is typically coiled on a reel for transport to a job site. At the job site, the deformed thermoplastic liner is conventionally pulled inside a pipe to be lined, i.e., a host pipe and then restored to its initially extruded cylindrical configuration with its outer cylindrical surface bearing against the interior cylindrical surface of the host pipe wall. The restoration of the deformed liner to its original cylindrical configuration is often carried out by the introduction of steam into the liner while in the host pipe whereby the liner is reformed to its cylindrical configuration and lines the host pipe. A well known system for lining pipes with a generally U-shaped liner which is reconfigured into a cylindrical liner upon installation is disclosed in various patents, namely U.S. Pat. Nos. 4,985,196; 4,863,365; 4,986,951; 4,998,871; 5,342,570; and 5,091,137, the subject matters of which are incorporated herein by reference.

For a substantial number of pipe lining installations, the liner, e.g., in a generally U-shaped configuration, is coiled on a reel and transported to the job site. The coiled liner typically has a sufficient length to extend between below-ground man openings. For example, a six inch or eight inch diameter thermoplastic pipe liner in a U-shaped configuration can be coiled on a reel in lengths up to about 2,000 feet and transported. It will be appreciated, however, that as the diameter of the deformed pipe liners increases, the length of the pipe capable of being coiled on a reel for transport to a job site decreases. For pipe liners beyond 18 inches in diameter, it becomes substantially impractical to coil the thermoplastic liner. However, there are many installations where host pipes in excess of 18 inches in diameter require lining. For those host pipes, linear lengths, e.g., 40-50 feet of deformed generally U-shaped thermoplastic liners are utilized since that length is about the largest length that can be practically transported to the job site. Host pipes, however, are typically in excess of those linear lengths of liner. Longer linear lengths are not practical due to the problem of transporting the fused lengths to the job site. Therefore it is necessary to fuse the pipe ends to one another at the installation site and in the generally deformed configuration, e.g., U-shaped configuration, prior to introduction into the host pipe.

It will be appreciated that thermoplastic material such as polyethylene used in the formation of pipe liners is a very ductile material and elastically deforms in response to temperature changes. The necessary transport of the deformed liner material and temperature changes between extrusion at the manufacturing site and installation at the job site causes the pipe ends to become asymmetrical. This asymmetry, as well as the thin wall thickness of the pipe liner, renders fusion of the pipe ends to one another at the installation site very difficult if not virtually impossible. This is also true with respect to coiled pipe liner. Accordingly, there has developed a need for apparatus and methods for enabling deformed pipe liner ends, e.g., U-shaped liner ends, to be fused to one another at an installation site.

### BRIEF DESCRIPTION OF THE INVENTION

In a preferred embodiment of the present invention, there is provided a method of joining opposed ends of thermoplastic pipes having correspondingly shaped non-cylindrical cross-sections comprising the steps of: (a) disposing an insert having a peripheral profile in part substantially corresponding to an internal profile portion of the shaped non-cylindrical cross-section of the pipes into each of the opposed pipe ends; and (b) while maintaining the inserts in the opposite ends of the pipes, fusing the opposed ends of the pipes to one another such that the fused joint has a cross-section corresponding to the shaped non-cylindrical cross-sections of the pipes.

In a further preferred embodiment of the present invention there is provided apparatus for joining opposed ends of thermoplastic pipes having correspondingly shaped non-cylindrical cross-sections comprising: first inserts having peripheral profiles in part substantially corresponding to internal profile portions of the shaped non-cylindrical cross-section of the pipes for insertion into the opposed pipe ends, respectively, and second inserts having peripheral profiles in part substantially corresponding to external profile portions of the shaped non-cylindrical cross-section of the pipes about the pipe ends, respectively, wherein said first and second inserts substantially maintain the profiles of the pipe ends in correspondence with one another during fusion thereof.

### BRIEF DESCRIPTION OF THE DRAWINGS

FIG. 1 is a fragmentary perspective view illustrating deformed pipe liner ends movable into positions for fusing the ends to one another;

FIG. 2 is a cross-sectional view of the pipe end illustrating an insert internal within the pipe end and an insert external to the pipe end;

FIG. 3 is a longitudinal cross-sectional view of the internal insert;

FIG. 4 is a cross-sectional view of the internal insert taken generally about on line 4-4 in FIG. 3;

FIG. 5 is a cross-sectional view thereof, taken generally about on line 5-5 of FIG. 3;

FIG. 6 is an end elevational view of the external insert;

FIG. 7 is a side elevational view at the external insert; and

FIG. 8 is a fragmentary longitudinal cross-sectional view of the pipe ends fused to one another with the inserts in place.

### DETAILED DESCRIPTION OF THE INVENTION

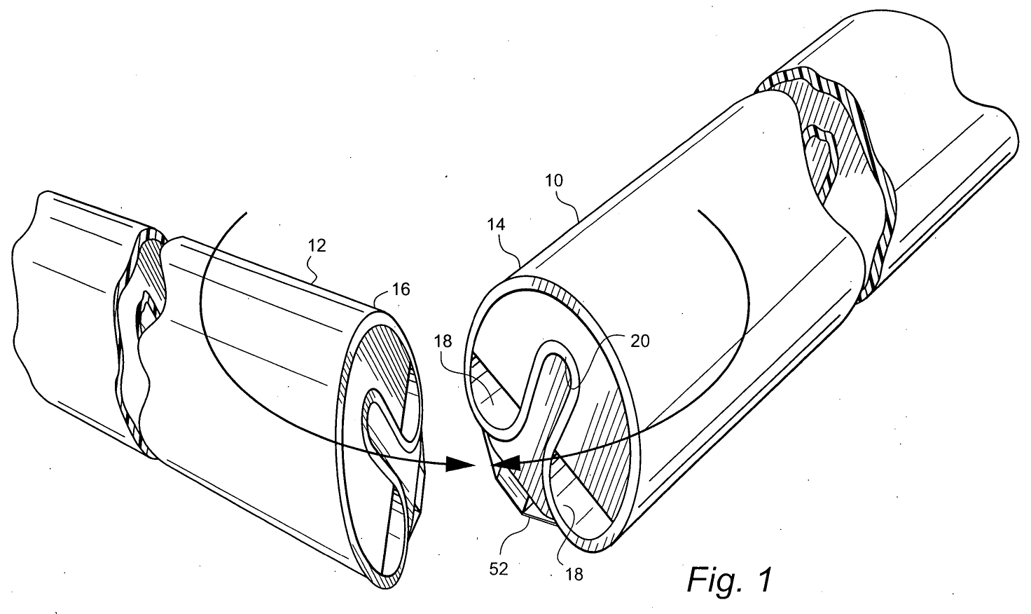

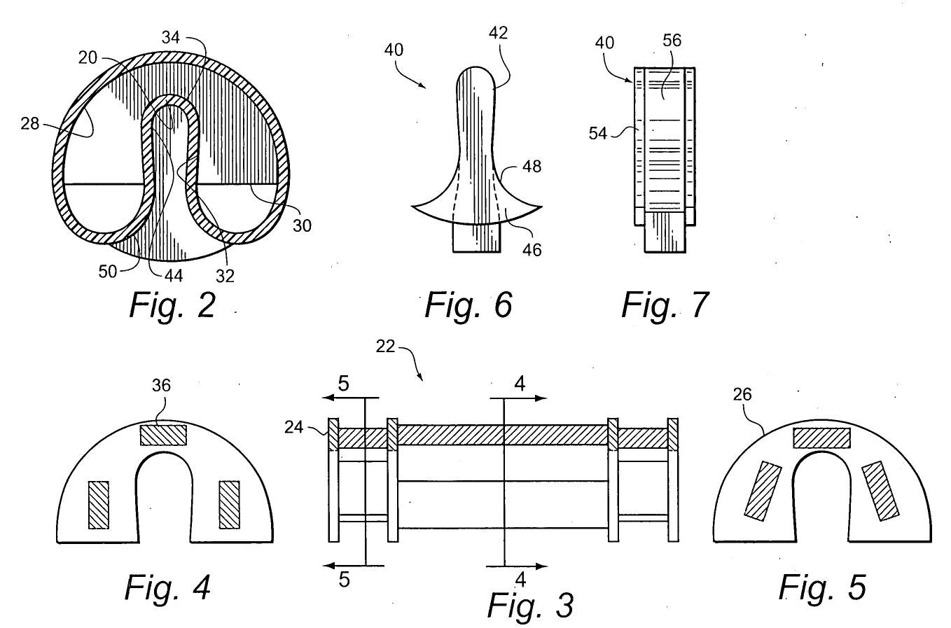

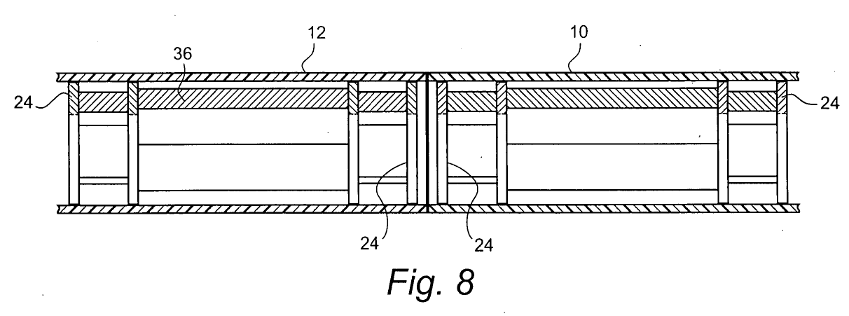

Referring now to the drawing figures, particularly to FIG. 1, there are illustrated portions of pipes 10 and 12 movable into in-line positions where the pipe ends 14 and 16 can be fused to one another. The pipes 10 and 12 are generally identical to one another in cross-sectional configuration although may have the same or different lengths and may be provided at an installation site either in linear lengths thereof or coiled on reels. The pipes 10 and 12 are formed of a thermoplastic material, e.g., polyethylene, at a fabrication site where the pipes 10 and 12 are extruded and have cylindrical cross-sections. From a review of FIGS. 1 and 2, it will be appreciated that the extruded cylindrical pipes 10 and 12 are deformed at the manufacturing site to reduce their cross-sectional envelope so that the pipes 10 and 12 can be received in host pipes and subsequently enlarged, i.e. returned to their original cross-sectional configurations to butt the interior walls of a host pipe whereby pipes 10 and 12 line the host pipe. The apparatus and processes for forming the thermoplastic pipes 10 and 12 and installing them in host pipes are described and illustrated in the above-identified U.S. patents. Suffice to say that the reduced cross-sectional configuration may be of a variety of shapes, such as H, X, U C and V shapes. The present description of the invention, however, will go forward using the U-shaped configuration as an exemplary embodiment of the invention and the various possible cross-sectional shapes of the pipes.

As illustrated in FIGS. 1 and 2, each of the pipe ends 14 and 16 has a cross-section including a pair of side lobes 18 which straddle a single inwardly directed central lobe 20 forming a generally U-shaped cross-sectional configuration. It will be appreciated that, by deforming the pipes 10 and 12 into the generally U-shaped configuration, the cross-sectional envelope of each pipe is reduced, enabling the pipe to be located, e.g., drawn into a host pipe and subsequently inflated, e.g., by steam, back to its original cylindrical configuration to line the host pipe. As noted above, the cross-sectional configurations of the pipes and particularly the ends of the pipes will change from the designed and fabricated cross-sectional configuration immediately after deformation as a result of temperature changes and handling of the pipes during coiling on a reel and/or transport from the fabrication site to a job installation site. As a consequence, the pipes which may be provided in linear lengths, e.g., up to 40-50 feet, enabling the pipe lines for transportation or coiled onto reels as disclosed in the above-identified patents, may have pipe ends which do not match one another, rendering substantial difficulty in fusing the ends of the pipes to one another during installation.

In order to provide pipe ends having a uniform cross-section at the installation site, inserts are provided for disposition in the pipe ends at the manufacturing site. The inserts maintain the pipe ends substantially uniform in cross-section from immediately after deformation of the pipe at the fabrication site until after the pipe ends are fused to one another at the installation site. To accomplish this, a first or interior insert generally designated 22 is provided. Insert 22 preferably has two or more profile sections 24 at opposite ends. Each profile section 24 includes a generally arcuate margin 26 having a similar profile as an internal arcuate wall portion 28 of the pipe end 14, 16. The profile section 24 extends along a chord line 30 which has a central opening 32 defining a margin corresponding to the internal margin 34 of the central lobe 20. Thus, the profile sections 24 have external margins which correspond to the larger internal arcuate margin of the pipe end, substantially excluding lobes 18 and accommodate the central lobe 20.

Preferably, the first insert 22 is elongated and has a pair of axially spaced profile sections 24 at each of its opposite ends as illustrated in FIG. 3. Consequently, at the fabrication site and after deformation, an insert 22 may be disposed within each pipe end. An end profile section 24 may lie flush with or spaced slightly back from the end of the pipe. The length of each insert 22 is such that the opposite pairs of profile sections 24 at opposite ends provide stability to the insert within the pipe end and preclude the profile sections 24 from canting or assuming a position otherwise than normal to the axis of the pipe. The insert 22 may be formed of any suitable materials, for example, wood, with the profile sections 24 being joined by longitudinally extending stringers 36 which, for example, may comprise wooden 2×4's.

Referring to FIGS. 6 and 7, a second or external insert, generally designated 40 is provided each end of the pipes. The second insert 40 has a peripheral profile 42 which corresponds in part substantially to the external profile portion 44 of the central lobe 20. Flanges 46 on opposite sides of the second insert 40 define arcuate surfaces 48 which conform to the curved external surfaces 50 forming portions of the outer lobes 18 of the pipe. The second insert 40 is inserted into the central lobe at the manufacturing site after deformation of the pipe ends and is strapped in place, for example, by the straps 52 illustrated in FIG. 1. As illustrated in FIG. 7, the second insert 40 may include profile sections 54 spaced axially one from the other with a central support stanchion 56 therebetween. The spaced profile sections 54 afford stability to the second insert 40 when received in the central lobe 20.

When the first and second inserts 22 and 40, respectively, are located within the pipe ends at the manufacturing site and after deformation of the pipe, it will be appreciated that the inserts maintain the cross-sectional configuration, e.g., the U-shaped configuration, of the pipe ends substantially uniform until such time, subsequent to the fusing of the pipe ends to one another at the installation site, that the inserts are removed. Thus, the pipes may be transported from the pipe fabrication site to a job installation site with the pipe ends maintaining uniform cross-sections. Further, the inserts remain attached to the pipe ends as the pipe is disposed, e.g., drawn into a host pipe such that a pipe end and its inserts project from an end of the host pipe.

At the installation site, one of the pipes is drawn into the host pipe, leaving an end of the pipe with inserts therein exposed from the host pipe end. The end of the second or next pipe can then be matched with the end of the pipe located in the host pipe. That is, the ends of the pipes can be butted one against the other with assurance that the cross-sectional configurations, e.g., the U-shaped configuration of the pipe ends, will match one another exactly. With the ends butted, and the inserts remaining in place, the pipe ends can be fused to one another using conventional fusing machines. The outside inserts 40 are then removed from the fused pipe ends. Subsequent to fusing the pipe ends and removal of the outside inserts 40 the first pipe is advanced along the host pipe locating the fused pipe ends and the second pipe in the host pipe. When the appropriate lengths of pipes lie within the host pipe, the pipes may be expanded by the introduction of steam such that the pipes return to their extruded cylindrical configuration, thereby lining the host pipe as set forth in detail in one or more of the above-identified patents. After the pipes have been expanded to line the host pipe, the inserts internal to the pipe ends can be removed by flowing water through the pipes to essentially float the inserts out of the pipes through an open pipe end or by use of a “pig” drawn through the pipe.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A method of joining opposed ends of thermoplastic pipes having correspondingly shaped non-cylindrical cross-sections comprising the steps of:
(a) disposing an insert having a peripheral profile in part substantially corresponding to an internal profile portion of the shaped non-cylindrical cross-section of the pipes into each of the opposed pipe ends; and
(b) while maintaining the inserts in the opposite ends of the pipes, fusing the opposed ends of the pipes to one another such that the fused joint has a cross-section corresponding to the shaped non-cylindrical cross-sections of the pipes.

2. A method according to claim 1 including locating each insert inset from the end of the corresponding pipe.

3. A method according to claim 1 including removing the inserts from the fused pipe ends.

4. A method according to claim 1 including disposing a second insert having a peripheral profile in part substantially corresponding to an external profile portion of the shaped non-cylindrical cross-section of the pipes about each of the opposed pipe ends and maintaining said second insert about each opposed pipe end while fusing the pipe ends to one another.

5. A method according to claim 1 including disposing a discrete insert, each including at least a pair of spaced apart peripheral profiles, into each of the opposite ends of the pipe, and locating the peripheral profiles of each insert at spaced locations along a length of each pipe end, respectively, to impart stability to the insert within the pipe end.

6. A method according to claim 1 wherein each of said opposed pipe ends has a cross-section including a pair of side lobes straddling a single inwardly directed lobe and including the steps of forming each insert to include a generally arcuate margin and a central opening along a chord thereof defining a second margin for receiving the inwardly directed lobe.

7. A method according to claim 6 including providing a second insert having a peripheral profile in part substantially corresponding to an external profile portion of the inwardly directed lobe of the pipes, disposing said second insert about each of the opposed pipe ends and about the external profile portion of the inwardly directed lobe, and maintaining said second insert about each opposed pipe end while fusing the pipe ends to one another.

8. A method according to claim 1 including forming said thermoplastic pipes at a manufacturing facility, performing step (a) at the manufacturing facility, transporting the manufactured pipes with the inserts disposed in the pipe ends to a pipe lining installation site, and performing step (b) at the pipe lining installation site.

9. A method according to claim 1 including forming said thermoplastic pipes at a fabrication facility, performing step (a) at the fabrication facility, transporting the fabricated pipes with the inserts disposed in the pipe ends to a pipe lining installation site, and performing step (b) at the pipe lining installation site including forming the thermoplastic pipes at the fabrication site into generally U-shaped cross sectional configurations.

10. Apparatus for joining opposed ends of thermoplastic pipes having correspondingly shaped non-cylindrical cross-sections comprising:
first inserts having peripheral profiles in part substantially corresponding to internal profile portions of the shaped non-cylindrical cross-section of the pipes for insertion into the opposed pipe ends, respectively, and
second inserts having peripheral profiles in part substantially corresponding to external profile portions of the shaped non-cylindrical cross-section of the pipes about the pipe ends, respectively, wherein said first and second inserts substantially maintain the profiles of the pipe ends in correspondence with one another during fusion thereof.

11. Apparatus according to claim 10 wherein said first inserts each include at least a pair of spaced apart peripheral profiles for insertion into each pipe end to stabilize the first insert within the pipe end.

12. A method according to claim 10 including disposing a first of said pipes in a host pipe at the installation site leaving an end thereof exposed from an end of the host pipe, locating a second thermoplastic pipe such that the ends of said first and second pipes are in alignment with one another and subsequently fusing the first and second pipe ends to one another.

13. A method according to claim 12 including providing said first and second pipes in linear lengths thereof prior to locating said first pipe in said host pipe.

14. A method according to claim 12 including providing said first and second pipes coiled on reels prior to locating said first pipe in said host pipe and fusing said first pipe subsequent to locating the first pipe in the host pipe to an end of the second pipe while the second pipe remains on the reel.
